(19) United States
(12) Patent Application Publication
(10) Pub. No.: US 2013/0030583 A1
(43) Pub. Date: Jan. 31, 2013

(54) Non-binding consumer premises energy forecast sharing in energy management system

(71) Applicant: James E. Owen, Vancouver, WA (US)

(72) Inventor: James E. Owen, Vancouver, WA (US)

(21) Appl. No.: 13/136,346

(22) Filed: Jul. 29, 2011

(51) Int. Cl. G06F 1/26

(52) U.S. Cl. 700/291

(57) ABSTRACT

An energy management system is augmented with sharing of non-binding consumer premises (CP) energy forecasts. Generally speaking, information sourced at a CP is received by CP equipment. The CP equipment creates a non-binding energy forecast for the CP using the CP-sourced information. The forecast is transmitted from the CP equipment to management premises (MP) equipment. The MP equipment may use the forecast to regulate at least one of electricity supply or demand at the CP.

### BACKGROUND OF THE INVENTION

The present invention relates to energy management systems and, more particularly, to information sharing in energy management systems.

There are several types of energy management systems deployed today. One type is a virtual power plant (VPP) system. A VPP system typically delivers power to participating customer premises by integrating distributed energy generation with demand-side management (DSM). A VPP system generally includes a communication system between a public utility or aggregator and participating customer premises that regulates electricity supply and demand at the customer premises to achieve predefined energy management objectives for the utility or aggregator, such as mitigating the load on the utility or aggregator during periods of peak electricity usage. Some VPP systems continually collect electricity usage data from the participating customer premises and mitigate the load on the electric utility or aggregator by issuing, as needed, demand response (DR) events that alter electricity supply and demand at the customer premises (for example, by activating an emergency generator or raising a temperature setting of a thermostat). In addition to electricity usage data collected from participating customer premises, some VPP systems rely on inferential information, such as weather data, to determine the nature and timing of DR events. VPP systems may also issue DR events to their participating customer premises in response to DR events issued by the public utility or aggregator. A characteristic shared by conventional VPP systems is that they are reactive; that is, DR events are issued to participating customer premises in response to current conditions and events.

Another type of energy management system manages the load at a multi-unit housing complex, such as an apartment or condominium complex, to achieve predefined energy management objectives for the complex. Similar to conventional VPP systems, energy management actions taken in conventional systems of this type are reactive to current conditions and events at the complex.

Some public utilities have implemented scheduling and bidding systems that allow these utilities and their customers to negotiate a schedule of future electricity usage at customer premises. While these scheduling and bidding systems proactively determine electricity usage at customer premises, they are impractical for many commercial and most residential customers who have neither the time nor the knowledge to negotiate schedules of future electricity usage at their premises. Additionally, the fact that these negotiated schedules are binding is a disincentive to widespread use of these scheduling and bidding systems.

### SUMMARY OF THE INVENTION

The present invention augments an energy management system with sharing of non-binding consumer premises (CP) energy forecasts. Generally speaking, information sourced at a CP is received by CP equipment. The CP equipment creates a non-binding energy forecast for the CP using the CP-sourced information. The forecast is transmitted from the CP equipment to management premises (MP) equipment. The MP equipment may use the forecast to regulate at least one of electricity supply or demand at the CP.

In some embodiments of the invention, the consumers are homeowners, the CPs are homes and the MP equipment is a VPP server node. A non-binding CP energy forecast is created for each CP by a home energy management system (HEMS) node using CP-sourced information, transmitted from the HEMS node to the VPP server node, and used by the VPP server node to regulate electricity supply and/or demand at the CP. The forecast may be combined with forecasts for other CPs participating in the VPP system and used to improve DR event decision-making and reduce the need for DR events by providing advance warning to a public utility or aggregator of future energy needs and enabling the utility or aggregator to take proactive measures to avoid DR events (e.g., by bringing-on additional plant production to meet heightened energy demands).

In other embodiments of the invention, the consumers are multi-unit housing complex owners, the CPs are multi-unit housing complexes and the MP equipment is a VPP server node. A non-binding CP energy forecast is created for each CP by a multi-unit housing complex management node using CP-sourced information, transmitted from the management node to the VPP server node, and used by the VPP server node to regulate electricity supply and/or demand at the CP.

In still other embodiments of the invention, the consumers are dwelling unit tenants, the CPs are dwelling units and the MP equipment is a multi-unit housing complex management node. A non-binding CP energy forecast is created by a dwelling unit node using CP-sourced information, transmitted from the dwelling unit node to the management node, and used by the management node to regulate electricity supply and/or demand at the CP. The forecast may be combined with forecasts for other dwelling units in the complex and used by the complex owner to enter a scheduling contract with a public utility and/or better meet energy needs during outages when the complex is off-grid and reliant on energy sourced from backup generators, storage and solar panels.

Regardless of the architecture of the energy management system, the non-binding CP energy forecasts of the invention are merely informational. There is no commitment on the part of any party to honor the forecasts by delivering, using or paying for electricity levels specified in the forecasts. Accordingly, a strong disincentive for electricity consumers to share electricity usage information is removed.

In one aspect of the invention, therefore, a method for augmenting an energy management system with sharing of non-binding consumer premises energy forecasts comprises the steps of receiving, on CP equipment, information sourced at a CP; creating, by the CP equipment, a non-binding energy forecast for the CP using the information; and transmitting, by the CP equipment, to MP equipment, the forecast.

In some embodiments, the energy management system is a VPP system, the CP equipment comprises a HEMS node and the MP equipment comprises a VPP server node.

In some embodiments, the energy management system is a VPP system, the CP equipment comprises a multi-unit housing complex management node and the MP equipment comprises a VPP server node.

In some embodiments, the energy management system is a multi-unit housing complex energy management system, the CP equipment comprises a dwelling unit node and the MP equipment comprises a multi-unit housing complex management node.

In some embodiments, the forecast estimates future electricity usage at the CP.

In some embodiments, the forecast includes an hour-by-hour future electricity usage estimate for each hour of a day.

In some embodiments, the forecast includes an hour-by-hour future electricity usage estimate for each hour of a week.

In some embodiments, the information includes a thermostat schedule.

In some embodiments, the information includes appliance configuration information.

In some embodiments, the information includes a vacation schedule.

In some embodiments, the method further comprises the step of detecting, by the CP equipment, a forecast reporting event.

In another aspect of the invention, CP equipment for an energy management system comprises a local interface; a remote interface; and a processor communicatively coupled with the local interface and the remote interface, wherein the CP equipment receives on the local interface information sourced at a CP, wherein the CP equipment under control of the processor creates a non-binding energy forecast for the CP using the information, and wherein the CP equipment transmits the forecast on the remote interface.

In yet another aspect of the invention, a method for augmenting an energy management system with sharing of non-binding consumer premises energy forecasts, comprises the steps of receiving, by management premises equipment, information sourced at a consumer premises; and regulating, by the management premises equipment, at least one of electricity supply or demand at the customer premises using a non-binding energy forecast for the customer premises obtained using the information.

In some embodiments, the information comprises the forecast.

In some embodiments, the regulating step comprises the substep of creating the forecast using the information.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a VPP system in some embodiments of the invention.

FIG. 2 shows a HEMS node in some embodiments of the invention.

FIG. 3 shows a method performed by a HEMS node for augmenting a VPP system with sharing of non-binding energy forecasts for CPs in some embodiments of the invention.

### DETAILED DESCRIPTION OF A PREFERRED EMBODIMENT

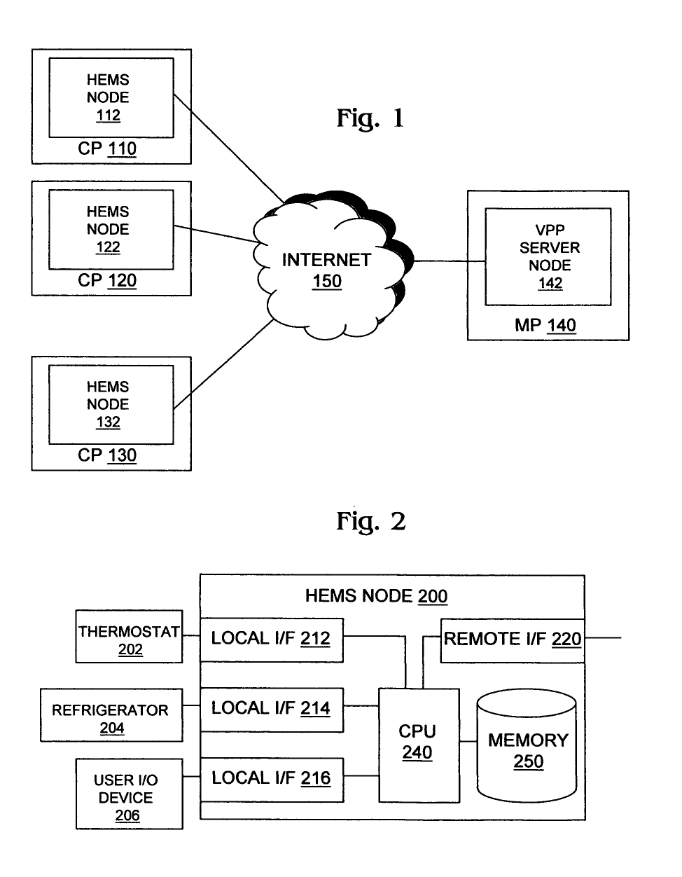

FIG. 1 shows a VPP system in some embodiments of the invention. The VPP system includes a multiple of HEMS nodes 112, 122, 132, resident at respective CPs 110, 120, 130. CPs 110, 120, 130 may be, for example, commercial premises such as shops and business offices or residential premises such as homes, condominiums and apartments. The VPP system also includes a VPP server node 142 resident at a MP 140, such as a public utility or aggregator premises. HEMS nodes 112, 122, 132 are interconnected with VPP server node 142 over the Internet 150. HEMS nodes 112, 122, 132 and VPP server node 142 communicate using standard communication protocols, such as Extensible Markup Language (XML), JavaScript Object Notation (JSON) and/or Remote Procedure Call (RPC), over Internet Protocol (IP). As part of this communication, HEMS nodes 112, 122, 132 report to VPP server node 142 non-binding energy forecasts for their respective CPs 110, 120, 130 in a VPP server node-ready format. The VPP system regulates electricity supply and/or demand at CPs 110, 120, 130 using the forecasts received from HEMS nodes 112, 122, 132 to achieve predefined energy management objectives, such as mitigating the load on a public utility or aggregator. Such regulation is achieved through issuance by VPP server node 142 of DR events. DR events can alter electricity supply and demand for the VPP system as a whole, for a subgroup of CPs within the VPP system, or for individual CPs. While the VPP system is shown to include three HEMS nodes 112, 122, 132 resident at respective CPs 110, 120, 130, the number of HEMS nodes and respective CPs within a VPP system may vary and will often be much larger (e.g., 1000 homes). Moreover, it bears noting that HEMS nodes 112, 122, 132 may be owned and/or managed by a public utility or aggregator or occupants of the CPs. Furthermore, while HEMS nodes 112, 122, 132 are shown and described as being resident at respective CPs 110, 120, 130, HEMS nodes 112, 122, 132 in other embodiments may be installed outside their respective CPs 110, 120, 130. Similarly, while VPP server node 142 is described as being resident at management premises 140, VPP server node 142 in other embodiments may reside off-site.

FIG. 2 shows a HEMS node 200, which is representative of HEMS nodes 112, 122, 132, in some embodiments of the invention. HEMS node 200 has a processor 240 communicatively coupled between a multiple of local interfaces 212, 214, 216 and a remote interface 220. Processor 240 is also communicatively coupled with a memory 250. In some embodiments, processor 240 is a microprocessor that performs the operations attributed to processor 240 herein by executing software instructions stored in memory 250. In other embodiments, the operations attributed to processor 240 herein may be carried out in part or in whole in custom logic.

CP devices 202, 204, 206, including a thermostat 202, a refrigerator 204 and a user input/output (I/O) device 206 are interconnected to HEMS node 200 via local interfaces 212, 214, 216, respectively. These local connections may include wired connections (e.g., wired Ethernet) and/or wireless connections (e.g., Wi-Fi, ZigBee, Bluetooth). User I/O device 206 may be a desktop, tablet or notebook computer or a smart phone, by way of example. HEMS node 200 is also interconnected to VPP server node 142 over the Internet 150 via remote interface 220.

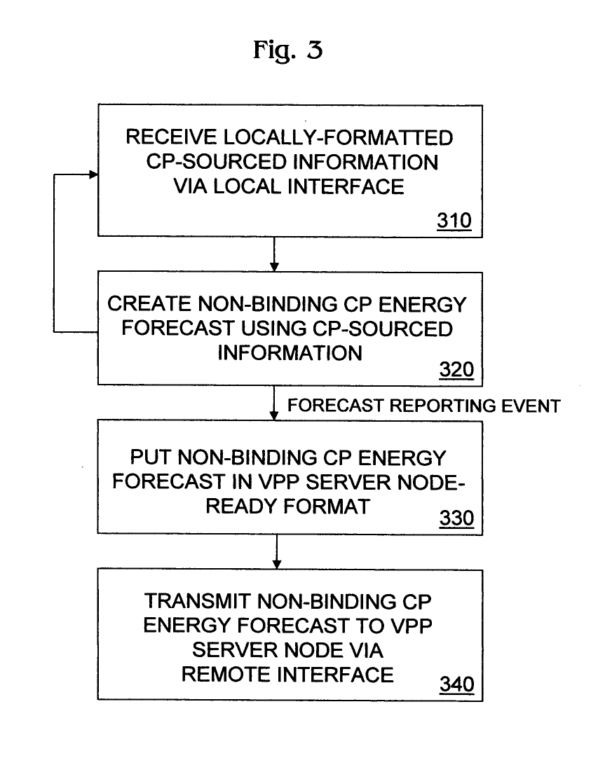

FIG. 3 shows a method performed by HEMS node 200 for augmenting a VPP system with sharing of non-binding energy forecasts for CPs in some embodiments of the invention.

At the outset, HEMS node 200 receives information from CP devices 202, 204, 206 in a local format via one or more of local interfaces 212, 214, 216 (310). This locally-formatted CP-sourced information is correlative with future energy consumption, storage and/or generation at the CP managed by HEMS node 200. In one example, an electricity consumer who occupies the CP manually inputs an hour-by-hour daily or weekly temperature control schedule on a user interface of thermostat 202 and thermostat 202 transmits the schedule to HEMS node 200 via local interface 212. In a second example, the consumer plugs-in a new refrigerator 204 and refrigerator 204 automatically transmits a configuration update to HEMS node 200 via local interface 214 notifying HEMS node 200 of an energy consumption profile for refrigerator 204. In a third example, the consumer manually inputs a vacation schedule on a user interface of user I/O device 206 and user I/O device 206 transmits the schedule to HEMS node 200 via local interface 216. It bears noting that the CP-sourced information received on HEMS node 200 is not limited to information correlative with electricity consumption, but may also include information correlative with electricity storage and/or electricity generation relative to, for example, solar panels and/or generators installed at the CP.

Next, HEMS node 200 under the control of processor 240 creates a non-binding energy forecast for the CP using the information received via one or more of local interfaces 212, 214, 216 (320). In one example, an hour-by-hour daily or weekly temperature control schedule received from thermostat 202 via local interface 212 is used to compute or update a forecast of hour-by-hour future electricity usage for each hour of the day or week. The temperature control schedule may be converted to an energy usage forecast using an algorithm that assumes average performance of the heating, ventilating and air conditioning (HVAC) system using seasonally adjusted national or regional average or a local average based on measured performance of other HVAC systems in the VPP system. Moreover, the temperature control schedule may be combined with other user-defined information received on local interface 216 and/or other assumptions to compute or update a total energy usage forecast for the CP (i.e., a CP energy forecast not limited to the HVAC system). In a second example, a vacation schedule received via local interface 216 is used to update the forecast. A fixed percent reduction in energy consumption during the vacation may be assumed based on a national or regional average or a local average at other customer premises in the VPP system. Once the forecast is computed or updated, the forecast is stored in memory 250 under the control of processor 240.

In some embodiments, a customer manually inputs a partial or complete hour-by-hour daily or weekly energy forecast on user I/O device 206 and user I/O device 206 transmits the partial or complete forecast to HEMS node 200 via local interface 216. In these embodiments, the non-binding energy forecast for the CP is not computed or updated by correlation with the CP-sourced information, but instead is created by direct incorporation of the manual inputs into the forecast.

HEMS node 200 performs CP-sourced information collection and non-binding CP energy forecast computation in a loop until processor 240 detects a forecast reporting event. In some embodiments, a forecast reporting event is detected when HEMS node 200 determines under the control of processor 240 that a newly computed or updated forecast significantly deviates from a previous forecast. By way of example, a forecast reporting event may be detected if it is determined that an electricity usage estimate for any hour of the day or week within the forecast has changed by more than one percent. In other embodiments, a forecast reporting event is detected when HEMS node 200 determines under the control of processor 240 that a scheduled reporting time has arrived. By way of example, HEMS node 200 may have a timer whose periodic expiration prompts HEMS node 200 under the control of processor 240 to transmit the current forecast to VPP server node 142. The forecast may be bundled with other electricity usage information for the CP, such as meter readings received from an electricity meter and/or ambient temperature readings that can be applied by VPP server node 142 to correlate future weather conditions with future electricity consumption. In still other embodiments, a forecast reporting event is detected by receipt on HEMS node 200 via remote interface 220 of a request issued by VPP server node 142 for the current forecast. VPP server node 142 may request the current forecast when preparing to issue a DR event so that the DR event decision is made based on the most recent estimate of energy supply and demand in the VPP system. In still other embodiments, forecast changes, scheduled reports and/or requests issued by VPP server node 142 cooperatively trigger forecast reporting. For example, when HEMS node 200 makes a scheduled report to VPP server node 142 of meter readings, HEMS node 200 sets a flag in the meter report indicating that a forecast change has occurred. Then, in response to the flag, VPP server node 142 issues a request to HEMS node 200 for the current forecast and HEMS node 200 responds by transmitting a second report including the current forecast. For even greater efficiency, the request may be made by setting a flag in an acknowledgement message issued by VPP server node 142 in response to the meter report.

Returning now to FIG. 3, upon detecting a forecast reporting event, HEMS node 200 under the control of processor 240 places the forecast in a VPP server node-ready format (330). VPP server node-ready formatting includes generating a message in a format that conforms with protocol and messaging requirements imposed by the public utility or aggregator and that respects consumer privacy. For example, HEMS node 200 may strip-out and/or encrypt customer information that could be used to link the profile to the consumer to prevent the consumer's daily schedule from being discovered by unauthorized personnel.

Finally, HEMS node 200 under the control of processor 240 transmits the forecast to VPP server node 142 via remote interface 220 (340). VPP server node 142 may then apply the forecast, and non-binding energy forecasts for other CPs obtained from other HEMS nodes in the VPP system by similar means, to issue DR events regulating supply and/or demand at the CPs and take appropriate proactive measures such as bringing-on additional plant production to meet future energy demands indicated in the forecasts.

It will be appreciated by those of ordinary skill in the art that the invention can be embodied in other specific forms without departing from the spirit or essential character hereof. For example, in some embodiments, the VPP server node receives information from CP devices (e.g., thermostat, refrigerator, user I/O device) without preprocessing by a HEMS node and is responsible for performing format conversions and computing non-binding energy forecasts for the CPs using the information. The VPP server node then regulates electricity supply and/or demand at the CPs using the forecasts and takes appropriate proactive measures. In still other embodiments, information is communicated between the CPs and the MP using the public utility's advanced metering infrastructure (AMI) communication system, rather than via the Internet.

Moreover, the invention is applicable to other energy management systems. For example, in some embodiments, a VPP system includes a multiple of multi-unit housing complex management nodes at respective CPs of the system. The system also includes a VPP server node at an MP of the system. The management nodes report to the VPP server node non-binding energy forecasts for their respective CPs in a VPP server node-ready format. In still other embodiments, a multi-unit housing complex energy management system includes a multiple of dwelling unit nodes at respective CPs of the complex. The system also includes a multi-unit housing complex management node at an MP of the complex. The dwelling unit nodes report to the management node non-binding energy forecasts for their respective CPs in a management node-ready format. The management node uses the forecasts to achieve predefined energy management objectives, such as entering an appropriate scheduling contract with a public utility and/or better meeting energy needs of the CPs during outages when the complex is off-grid and reliant on energy sourced from backup generators and storage.

The present description is thus considered in all respects to be illustrative and not restrictive. The scope of the invention is indicated by the appended claims, and all changes that come with in the meaning and range of equivalents thereof are intended to be embraced therein.

What is claimed is:

1. A method for augmenting an energy management system with sharing of non-binding consumer premises energy forecasts, comprising the steps of:
receiving, on consumer premises equipment, information sourced at a consumer premises;
creating, by the consumer premises equipment, a non-binding energy forecast for the consumer premises using the information; and
transmitting, by the consumer premises equipment, to management premises equipment, the forecast.

2. The method of claim 1, wherein the energy management system is a virtual power plant system, the consumer premises equipment comprises a home energy management system node and the management premises equipment comprises a virtual power plant server node.

3. The method of claim 1, wherein the energy management system is a virtual power plant system, the consumer premises equipment comprises a multi-unit housing complex management node and the management premises equipment comprises a virtual power plant server node.

4. The method of claim 1, wherein the energy management system is a multi-unit housing complex energy management system, the consumer premises equipment comprises a dwelling unit node and the management premises equipment comprises a multi-unit housing complex management node.

5. The method of claim 1, wherein the forecast estimates future electricity usage at the consumer premises.

6. The method of claim 1, wherein the forecast includes an hour-by-hour future electricity usage estimate for each hour of a day.

7. The method of claim 1, wherein the forecast includes an hour-by-hour future electricity usage estimate for each hour of a week.

8. The method of claim 1, wherein the information includes a thermostat schedule.

9. The method of claim 1, wherein the information includes appliance configuration information.

10. The method of claim 1, wherein the information includes a vacation schedule.

11. Consumer premises equipment for an energy management system, comprising:
a local interface;
a remote interface; and
a processor communicatively coupled with the local interface and the remote interface, wherein the consumer premises equipment receives on the local interface information sourced at a consumer premises, wherein the consumer premises equipment under control of the processor creates a non-binding energy forecast for the consumer premises using the information, and wherein the consumer premises equipment transmits the forecast on the remote interface.

12. The equipment of claim 11, wherein the forecast estimates future electricity usage at the consumer premises.

13. The equipment of claim 11, wherein the forecast includes an hour-by-hour future electricity usage estimate for each hour of a day.

14. The equipment of claim 11, wherein the forecast includes an hour-by-hour future electricity usage estimate for each hour of a week.

15. The equipment of claim 11, wherein the information includes a thermostat schedule.

16. The equipment of claim 11, wherein the information includes appliance configuration information.

17. The equipment of claim 11, wherein the information includes a vacation schedule.

18. A method for augmenting an energy management system with sharing of non-binding consumer premises energy forecasts, comprising the steps of:
receiving, by management premises equipment, information sourced at a consumer premises; and
regulating, by the management premises equipment, at least one of electricity supply or demand at the customer premises using a non-binding energy forecast for the customer premises obtained using the information.

19. The method of claim 18, wherein the information comprises the forecast.

20. The method of claim 18, wherein the regulating step comprises the substep of creating the forecast using the information.
